(19) United States
(12) Patent Application Publication
(10) Pub. No.: US 2017/0256962 A1
(43) Pub. Date: Sep. 7, 2017

(54) INTERMEDIATE STORAGE FACILITY FOR BATTERY UNITS

(71) Applicant: Deutsche Post AG, Bonn (DE)

(72) Inventors: Olaf Elsen, Wuerselen (DE); Jens Bockstette, Neuss (DE)

(21) Appl. No.: 15/450,662

(22) Filed: Mar. 6, 2017

(30) Foreign Application Priority Data
Mar. 7, 2016 (DE) 10 2016 002 620.0
Mar. 17, 2016 (DE) 10 2016 104 989.1

(51) Int. Cl. H02J 7/00; H02M 7/44; B60L 11/18; H02M 7/04

(52) U.S. Cl. CPC H02J 7/0014; H02M 7/04; H02M 7/44; B60L 11/1822

(57) ABSTRACT

The invention relates to an intermediate storage facility for battery units, having a multiplicity of battery units, having an inverter and/or rectifier, a power supply system and a controller, wherein each battery unit has at least one chargeable battery cell and a battery management system for monitoring and regulating the battery cell, at least two battery units are connected electrically in series to form a battery chain, the battery chain is electrically connected to the power supply system via the inverter and/or rectifier, and the controller has a communication connection to all the battery management systems and is configured to bring about charging of the battery cell with electrical energy from the power supply system, to feed electrical energy in to the power supply system by discharging the battery cell and/or to bring about connection and/or disconnection of the battery unit to or from the inverter and/or rectifier.

### CROSS-REFERENCE TO RELATED APPLICATIONS

This application claims the foreign priority benefit of German Patent Application No. 10 2016 002 620.0 filed Mar. 7, 2016 and German Patent Application No. 10 2016 104 989.1 filed Mar. 17, 2016, which are both hereby incorporated by reference.

### BACKGROUND

The invention relates to an intermediate storage facility for battery units, having a multiplicity of battery units, having an inverter and/or rectifier, a power supply system and a controller, wherein each battery unit has at least one chargeable battery cell and a battery management system for monitoring and regulating the battery cell, and the battery units are electrically connected to the power supply system via the inverter and/or rectifier.

As a result of the ever increasing number of electric vehicles or hybrid vehicles and other traction applications, battery units are increasingly required as high-voltage battery systems having lithium-ion cells or the like. In addition to the energy-storing battery cells, such battery units have a battery management system which can monitor and regulate the battery cells in terms of the state of charge, the cell voltage, temperature and the like. In order to optimize the service life of the costly battery units, continuous discharging and charging is necessary.

This process which is also referred to as cyclization causes high operational expenditure on the manufacturers of battery units since, on the one hand, battery units which are stored in a spare part storage facility and, on the other hand, battery units which are stored in an intermediate storage facility and are provided for upcoming installation in an electric vehicle have to be continuously cyclized, which involves considerable expenditure. Systems which are known from the prior art for cyclization are distinguished by a high electrical performance loss and associated costs for the necessary inverters and/or rectifiers as well as complex storage logistics.

Taking this situation as a starting point, an object of the invention is to specify an intermediate storage facility with which cyclization of battery units is possible in a particularly simple and cost-effective manner.

### SUMMARY

The object of the invention is achieved by means of the features of the independent claims. Advantageous refinements are provided by the features of the dependent claims.

Accordingly, the object is achieved by means of an intermediate storage facility for battery units, having a multiplicity of battery units, having an inverter and/or rectifier, a power supply system and a controller, wherein each battery unit has at least one chargeable battery cell and a battery management system for monitoring and regulating the battery cell, at least two battery units are connected electrically in series to form a battery chain, the battery chain is electrically connected to the power supply system via the inverter and/or rectifier, and the controller has a communication connection to all the battery management systems and is configured to bring about charging of the battery cell and/or of the battery unit with electrical energy from the power supply system, to feed electrical energy in to the power supply system by discharging the battery cell and/or the battery unit and/or to bring about connection and/or disconnection of the battery unit to or from the inverter and/or rectifier.

An essential aspect of the invention is that the battery units are connected electrically in series in a battery chain. Compared with a single battery unit or a parallel connection of a plurality of battery units, a higher voltage is achieved in this way on the battery side at the inverter and/or rectifier, which makes it possible to use, on the one hand, more cost-effective inverters and/or rectifiers and, on the other hand, to use inverters and/or rectifiers with significantly lower electrical transmission losses. In addition, performance system fluctuations of the power supply system during the discharging or charging of the battery cells or of the battery unit owing to the relatively high voltage on the battery side can be compensated significantly more efficiently. As a result of the arrangement of battery cells or of the battery unit in a battery chain, it is also possible to exchange a battery cell or the battery unit or all the battery cells or all the battery units of the battery chain significantly more easily in the intermediate storage facility. Finally, owing to the use of just a single inverter and/or rectifier instead of an inverter and/or rectifier assigned separately to each battery unit the proposed arrangement is distinguished by significantly lower manufacturing costs.

Basically, it is possible to use any battery units which are configured in particular for use in electric vehicles or hybrid vehicles or other traction applications and preferably as high-voltage systems with lithium-ion cells or the like. The chargeable battery cell is preferably embodied as an accumulator cell with a secondary cell, wherein a multiplicity of secondary cells are more preferably provided electrically connected in series and/or in parallel. The battery management system preferably comprises a state-of-charge detection means, a data interface and/or performance electronics for charging or discharging for the battery cell or the battery unit, in order to monitor and regulate the battery cell or the battery unit. Alternatively or additionally, the inverter and/or rectifier comprises performance electronics for charging or discharging for the battery cell or the battery unit. The power supply system is preferably configured as a public means system, and is made available by a power supply company. The controller is preferably computer-based and has an interface for connecting to the data interface of the battery management system for exchanging data and controlling same.

As a result of the proposed arrangement, the energy consumption during the manufacture of battery units can advantageously be reduced. In an exemplary application, battery units which have been manufactured and/or are assigned for installation in an electric vehicle are made available with a low state of charge in the intermediate storage facility and economically recharged overnight at favourable energy prices or when there is an excess of energy in the power supply system, for example when there is strong wind, and as a result the energy prices are favourable. When the battery units are discharged, the electrical energy can be used to manufacture the battery units or can be fed into the power supply system. In addition, further energy generators such as cogeneration performance units, photovoltaic elements and/or wind energy can be used to charge the battery units and/or to heat the intermediate storage facility. In a further exemplary application, a first battery chain as a generator of electrical energy can be assigned to a first performance-system-side consumer, and a second battery chain can be assigned as a consumer of electrical energy to a first performance-system-side generator, by means of the controller. For this purpose, a control method which controls the charging or discharging of the battery chains according to predefined criteria such as the state of charge or the like can be carried out at the controller.

As a result, by means of the proposed arrangement it is possible to ensure that battery units are available simultaneously by removing them from the intermediate storage facility, battery units can be placed in the intermediate storage facility and given a predefined state of charge there, electrical energy is made available for the manufacture of the battery units, regulating energy and regulating performance is made available for the performance system operator in order to compensate for performance system fluctuations of the power supply system, and during the charging of battery chains with a cogeneration performance unit or the like it is also possible additionally to coordinate heat in such a way that the energy consumption and the operating costs are significantly lower compared to refinements known from the prior art. In addition, by connecting the intermediate storage facility to the power supply system it is possible to achieve monetary gains from the provision of primary control performance. In addition, functions such as incoming goods inspection or outgoing goods inspection, maintenance and test possibilities of the battery units can be easily integrated by the electrical use of the latter in the intermediate storage facility.

According to one preferred development a multiplicity of battery chains which are respectively connected to the inverter and/or rectifier and connected electrically in parallel with one another is provided. An equally large number of battery units is preferably provided in each battery chain. The battery chains can preferably be connected individually to the inverter and/or rectifier by means of the controller. An access lock and/or locking means are also preferably provided in order to protect the battery unit against unplanned removal or during the charging, for example. The access lock and/or locking means can preferably be controlled by the controller.

According to a further preferred development, a multiplicity of inverters and/or rectifiers and in each case a battery chain which is electrically connected to the performance system terminal via the respective inverter and/or rectifier is provided. In this refinement, each battery chain is assigned an individual inverter and/or rectifier, but each inverter and/or rectifier can in turn make electrical contact with a multiplicity of parallel battery chains. For example, two inverters and/or rectifiers can be provided which make electrical contact with two battery chains on each side of the intermediate storage facility.

Basically, various methods for charging or discharging the battery units may be implemented by means of the controller. However, according to one particularly preferred refinement, the controller is designed to select a battery chain, so that the selected battery chain is charged with electrical energy from the power supply system within a time period and/or up to a time when it is made available, or feeds electrical energy into the power supply system. Through such selective charging and discharging it is possible, for example, to implement an energy load management system for the manufacture of the battery units, or a performance system operator can be assisted in carrying out planned equalization of supply fluctuations in the power supply system.

There are also various possibilities suitable for the communication between the controller and battery management systems. A field bus by which the controller is connected to the battery management systems and/or to the inverter and/or rectifier has proven particularly advantageous. An interface for the field bus is preferably provided at the battery unit, and the battery management systems are configured with a communication unit for communicating via the field bus. By providing a field bus it is possible in a particularly simple manner to control the battery units with respect to charging, discharging, disconnection and/or connection.

According to one preferred development, 3, 4, 5, 8, 10 or 12 battery units are connected electrically in series in the battery chain, each battery unit has a rated voltage of ≧250V and ≦1 kV, in particular 360V, 400V, 600V or 700V and/or the inverter and/or rectifier has on the battery chain side a rated voltage of ≧1 kV and ≦5 kV, in particular ≧2 kV and ≧3 kV, and/or on the power supply system side has a rated voltage of ≧10 kV and ≦30 kV. A person skilled in the art will select suitable combinations from these values. If, for example, in each case, 12 battery units with, in each case, 250V rated voltage are respectively connected in series in two parallel battery chains, a rated voltage of 3 kV would be present on the battery chain side or battery side at the inverter and/or rectifier.

In one particularly preferred refinement, the intermediate storage facility has a shelf system with at least two shelves, wherein at least two battery chains and a loading device are provided, each battery chain is arranged on a respective shelf, and the loading device is configured to automatically insert the battery unit into the shelf, or remove said battery unit therefrom, and to electrically disconnect or connect the battery unit to the battery chain and/or lock said battery unit to the shelf. The loading device is preferably embodied as a loading robot and/or can be controlled by the controller. The shelves are preferably arranged opposite one another, with the result that the loading device can insert, remove and/or replace the battery unit into or from the shelves. A multiplicity of shelves is also preferably provided arranged one on top of the other and/or the shelves are dimensioned in such a way and/or provided in such numbers that ≧100, ≧200 and/or ≦500 battery units can be intermediately stored on the shelves.

In this context, it is particularly preferred that the intermediate storage facility has a device for performing input control, output control and/or end-of-line testing of the battery unit. The loading device is preferably designed to carry out the input control, output control and/or end-of-line testing and to transmit the result thereof to the controller.

The object of the invention is additionally achieved by a method for storing a battery unit in an intermediate storage facility as described above, having the step:
exchanging all the battery units of each battery chain at the latest after 21 days, preferably 14 days and at the latest after an energy throughput of the battery chain of ≦3000 kWh, preferably ≦2000 kWh,
charging the battery unit during times of favourable electricity costs, and/or
charging and/or discharging the battery unit in order to compensate for performance system fluctuations of the power supply system.

The method advantageously achieves that the battery units according to the first alternative remain in the intermediate storage facility only for a limited storage period and only for a limited energy throughput. According to the second alternative, the energy costs for the charging can be optimized by the fact that the battery units are charged preferably only at times with favourable energy costs, for example at night. In the third alternative, performance system fluctuations are compensated, as a result of which the quality of the voltage in the power supply system is improved, in particular the level of the voltage, frequency, curve shape is improved and/or interference is reduced. The time until the exchange of the battery units of each battery chain is advantageously defined as a function of the storage capacity of the intermediate storage facility, in particular as a function of the battery units required per day. The energy throughput is also advantageously determined as a function of the energy content of the battery units, which can be 20 to 40 kWh, by way of example.

The invention will be explained in detail below with reference to the appended drawings, in which:

### BRIEF DESCRIPTION OF THE DRAWINGS

FIG. 1 shows a schematic illustration of the intermediate storage facility according to a preferred exemplary embodiment of the invention, and

FIG. 2 shows a flow chart relating to the equipment of the intermediate storage facility.

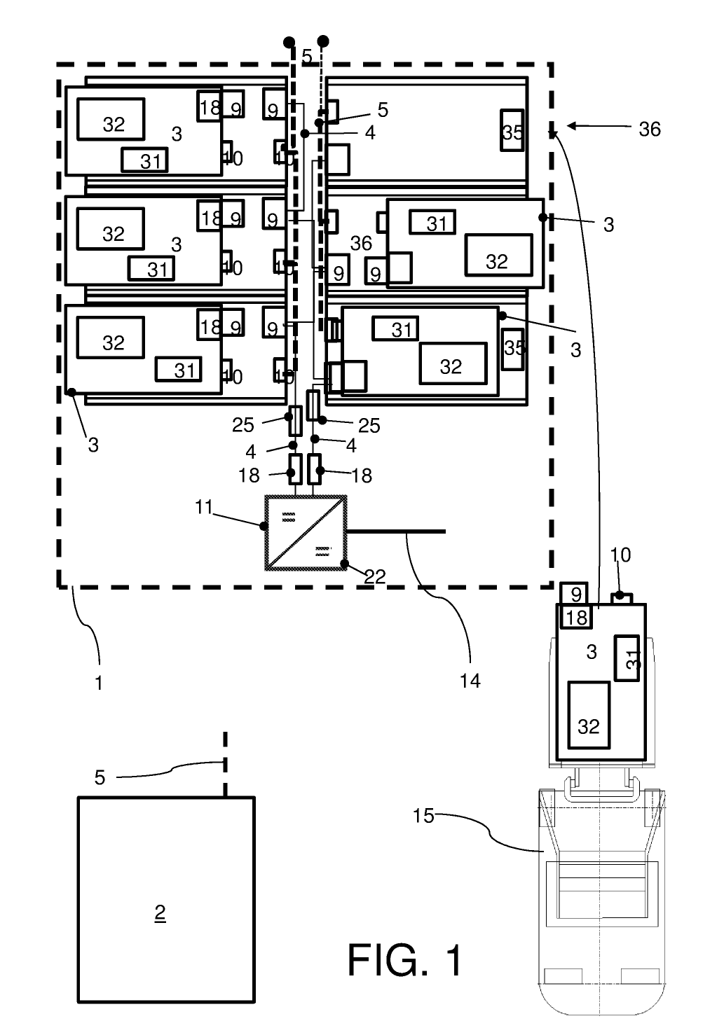

FIG. 1 shows a schematic illustration of an intermediate storage facility 1, also referred to as a battery production store, with a central controller 2 and a multiplicity of battery chains 6 with a rectifier and/or inverter 11 and battery units 3 with interfaces 9 and 10 for connecting the battery units 3.

### DETAILED DESCRIPTION OF THE DRAWINGS

The battery units 3 each have a battery cell 31 and a battery management system 32. In FIG. 1, in each case three battery units 3 are connected electrically in series to form a battery chain 6 via energy transmission interfaces 9 and energy transmission lines 4. The transmission lines 4 of the two battery chains 6 are connected to the inverter and/or rectifier 11, which is in turn connected via further energy transmission lines, indicated in FIG. 1, to a power supply system 14.

Each battery unit 3 also has a signal interface 10 by means of which the battery management system 32 is connected via a field bus 5 to the controller 2, as is illustrated indicatively in FIG. 1. The battery management system 32 can be used to determine internal operating states of the respective battery unit 3, for example by means of a current sensor, voltage sensor, or temperature sensor, in order to transmit to the controller 2 information about the state of charge of the respective battery cell 31, an identifier of the respective battery unit 3 to a storage location of the battery unit 3 in the intermediate storage facility 1 or fault information about faults which have occurred. Alternatively, instead of a field bus connection 5 a radio link can be provided from each of the battery units 3 to the central controller 2, in order to transmit the corresponding information and to centralize it in the central controller 2.

A total of 6 shelf locations 36 for respectively accommodating a battery unit 3 are illustrated in FIG. 1. In order to demonstrate the method of functioning, battery units 3 of the battery chain 6, illustrated on the left in FIG. 1, are inserted into the shelf locations 36, but the energy-transmission interfaces 9 and signal interfaces 10 of the battery units 3 are not yet electrically connected to the corresponding energy-transmission interfaces 9 and signal interfaces 10 of the left-hand battery chain 6. In the shelf location 36, illustrated at the bottom in FIG. 1, of the right-hand battery chain 6 the energy-transmission interface 9 and signal interface 10 of the battery unit 3 are connected to the battery chain 6. In the shelf location 36 which is shown at the top in FIG. 1, a battery unit 3 is inserted by means of a loading device 15 which is described in more detail below.

The central controller 2 has an external communication interface (not shown) for receiving and/or outputting information, which communication interface is connected, for example, to a central control station of a performance system operator of the power supply system 14. The external communication interface can be a wire-bound performance system connection, a radio link and/or a field bus connection. Load requirements and demand figures for battery units 3 from the production facility, as well as control performance requirements and current electricity prices from the control station of the performance system operator. Furthermore, the central controller 2 can also receive and store performance and energy forecasts of the connected battery chains 6. The controller 2 is primarily designed to control the current of the battery chain 6 across the inverters and/or rectifiers 11. The current which is to be adjusted by the controller 2 can be selected and interrupted in accordance with a load curve or by means of electricity price information.

The inverter and/or rectifier 11 is of bidirectional design, with the result that, on the one hand, electrical energy can be transmitted from the power supply system 14, via a performance system transmission terminal 22, the further transmission line, via a coupling element 18, a fuse device 25 and the energy transmission line 4, to the connected battery unit 3 in order to charge it, and, on the other hand, electrical energy can be transmitted in the opposite direction back into the power supply system 14 from the battery units 3. The central controller 2 also has a microprocessor which is connected to the field bus 5 via a communication interface. The control unit serves to monitor the flow of energy from and to each battery chain 6 via the inverters and/or rectifiers 11 and the battery interfaces 9, and to control the inverters and/or rectifiers 11 in accordance with a storage and energy provision function in such a way that load optimization is carried out.

The central controller 2 can also detect individual states of the inverter and/or rectifier 11 and detect differences in the loads, overloads and faults in the individual battery chains 6. If the loads of the battery chains 6 and of the battery units 3 are too large, the central controller 2 can decide to carry out compensation of the loads of the battery chains 6 by means of corresponding instruction via the field bus connection.

The control unit is also provided with a planning function with permits an availability time of the battery chains 6 to be defined as a function of the instantaneous state of charge of a connected battery chain 6, the time for which the battery unit 3 has been in the battery chain 6, the extracted current and the load request. For this, information about the use profile, the serial numbers and the battery chain membership, storage location and the state of charge of the used battery units 3 for each battery chain 6 is available to the control unit and, stored there. With this information, battery chains 6 with their battery units 3 can be available for as long as possible for optimizing the energy load. In an analogous fashion, if it is known that a specific battery chain 6 with battery units 3 is no longer required for load optimization, information can be made available to the production facility via the central controller 2, so that the corresponding battery units 3 can be picked up for the production facility or for delivery and replaced with new battery units 3.

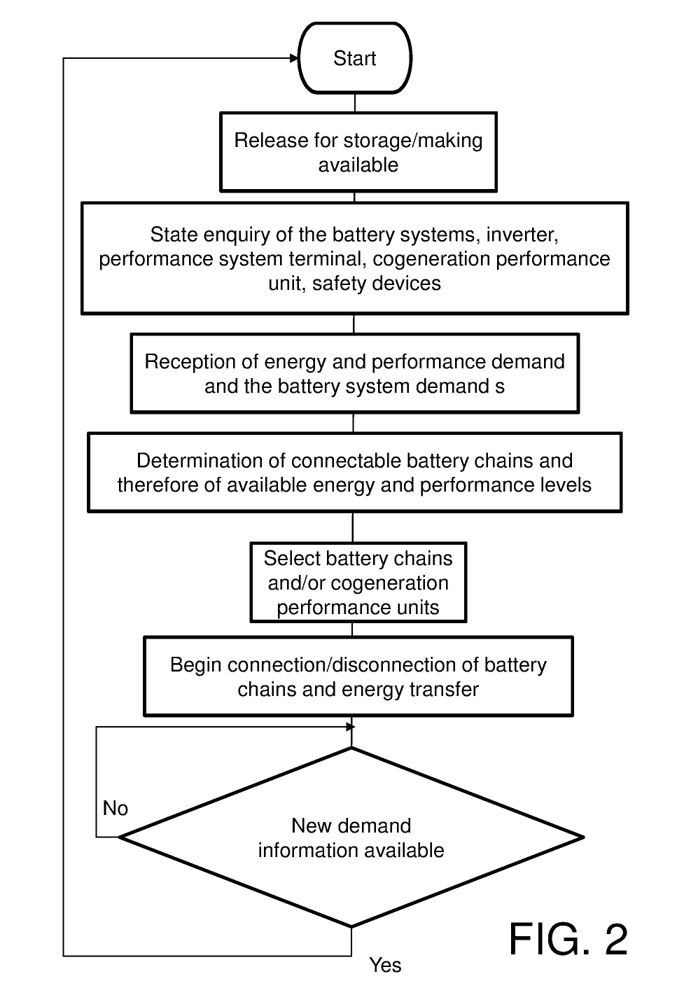

Referring to the flowchart in FIG. 2, the functions of the intermediate storage facility 1 will be described in more detail below. The intermediate storage facility 1 is embodied as a shelf system with inserts for battery units 3 and a plurality of energy transmission interfaces 9 and 22 for the serial connection of the battery units 3 to form battery chains 6 and to the power supply system 14 with a plurality of inverters and/or rectifiers 11.

The connection of the battery units 3 can be carried out manually as well as in an automated or partially automated fashion with the loading device 15, with the result that when the battery units 3 are inserted into the corresponding shelf location 36, the connections 9 and 10 are made automatically. In this way, the intermediate storage facility 1 can be operated not only at reaching height or ladder heights but also in high-rack storage arrangements. In the first step, safety devices such as locks, access locks, states of the battery chains 6 and the inverter and/or rectifier 11 are interrogated. Then, information from unused and released battery chains 6 as well as the battery units 3 contained therein is communicated to the production facility via the communication interface and the field bus 5. The controller 2 receives demand information about required energy and performance from the production facility or the performance system operator and the required number of battery units 3 for the production facility either by inputting at a user interface (not shown) or via the external communication interface and the field bus 5.

The demand information indicates essentially what performance and energy is required by the production facility or the performance system operator, and how many battery units 3 are required at what times in the production facility. The control unit determines the available and transmissible performance and quantity of energy as a function of the number of connected battery chains 6, performance capability of the inverters and/or rectifiers 11, and the performance information and states of charge of the battery units 3 connected in the battery chain 6. Furthermore, the controller 2 compares the available performance and energy and the number of released battery units 3 and free locations 36 with the requirements of the production facility and of the performance system operator as well as with the electricity price for the charging of the battery units 3.

The required battery chains 6 which can be connected to the power supply system 14 via the inverter and/or rectifier 11 within a time specified by the demand information are correspondingly selected in the next step in accordance with the demand information, so that the performance and energy requirement can be met. Additionally required battery chains 6 are connected, and battery chains 6 which are not required are disconnected and released. Battery units 3 which are to be made available in accordance with the demand information are selected and released, according to their serial number, storage date and ageing as a result of use. The selection is prioritized in accordance with the period of storage, ageing and the use profile as well as the lowest state of charge. The sequence and therefore the earliest provision period for a battery chain 6 are calculated from the previously described parameters and values.

For the other battery chains 6 which are connected and selected, the energy and performance is made available in accordance with the demand requirements and fed in to the power supply system 14. As a result of the short storage time, charging and storage which are beneficial for the service life are not necessary, since the battery units 3 are continuously replaced by new ones and are not stored or used for a long time during ongoing production. In the last step, the system waits for new demand information, or new demand information from the history of the load distribution, in particular of the production facility, is automatically also taken into account and stored in the controller. If new demand information is available, this is the case—alternatively: yes, the system jumps back to the step of the interrogation of the states of the battery chain.

### LIST OF REFERENCE NUMBERS

1 Intermediate storage facility
2 Central controller
3 Battery unit
4 Energy-transmission line
5 Field bus
6 Battery chain
9 Energy transmission interface
10 Communication unit with interface
11 Inverter or rectifier
14 Power supply system
15 Loading device
18 Coupling element
25 Fuse device
31 Battery cell
32 Battery management system
36 Shelf location

We claim:

1. Method for storing a battery unit in an intermediate storage facility, having a multiplicity of battery units, having an inverter and/or rectifier, a power supply system and a controller, wherein
each battery unit has at least one chargeable battery cell and a battery management system for monitoring and regulating the battery cell,
at least two battery units are connected electrically in series to form a battery chain,
the battery chain is electrically connected to the power supply system via the inverter and/or rectifier, and
the controller has a communication connection to all the battery management systems and is configured to bring about charging of the battery cell and/or of the battery unit with electrical energy from the power supply system, to feed electrical energy in to the power supply system by discharging the battery cell and/or the battery unit and/or to bring about connection and/or disconnection of the battery unit to or from the inverter and/or rectifier, and comprising the step:
exchanging all the battery units of each battery chain at the latest after 14 days and at the latest after an energy throughput of the battery chain of ≦3000 kWh.

2. Method according to claim 1, having a multiplicity of battery chains which are respectively connected to the inverter and/or rectifier and connected electrically in parallel with one another.

3. Method according to claim 1, having a multiplicity of inverters and/or rectifiers and each having one battery chain which is electrically connected to the power supply system via the respective inverter and rectifier.

4. Method according to claim 1, wherein the controller is designed to select a battery chain so that the selected battery chain is charged with electrical energy from the power supply system within a time period and/or up to a time when it is made available, or feeds electrical energy into the power supply system.

5. Method according to claim 1, having a field bus by which the controller is connected to the battery management systems and/or to the inverter and/or rectifier.

6. Method according to claim 1, wherein 3, 4, 5, 8 or 10 battery units are connected electrically in series in the battery chain.

7. Method according to claim 1, wherein each battery unit has a rated voltage of ≧250V and ≦1 kV.

8. Method according to claim 1, wherein the inverter and/or rectifier has on the battery chain side a rated voltage of ≧1 kV and ≦5 kV.

9. Method according to claim 1, wherein the power supply system side has a rated voltage of ≧10 kV and ≦30 kV.

10. Method according to claim 1, having a shelf system comprising at least two shelves, at least two battery chains and a loading device, wherein each battery chain is arranged on a respective shelf, and the loading device is configured to automatically insert the battery unit into the shelf, or remove said battery unit therefrom, and to electrically disconnect or connect the battery unit to the battery chain and/or lock said battery unit to the shelf.

11. Method according to claim 10, comprising a device configured to perform input control, output control and/or end-of-line testing of the battery unit.

12. Method according to claim 1 and having the step:
exchanging all the battery units of each battery chain at the latest after an energy throughput of the battery chain of ≦2000 kWh.

13. Method according to claim 1 and having the step:
charging the battery unit during times of favourable electricity costs.

14. Method according to claim 1 and having the step:
charging and/or discharging the battery unit in order to compensate for performance system fluctuations of the power supply system.
